(19) United States
(12) Patent Application Publication
(10) Pub. No.: US 2002/0099562 A1
(43) Pub. Date: Jul. 25, 2002

(54) System and method of data exchange for electronic transactions with multiple sources

(76) Inventors: Michael George Bruce SR., Leesburg, VA (US); Bill Gareth Neely, Silver Spring, MD (US); Eben Schoeman, Falls Church, VA (US); Trevor J. Veary, Reston, VA (US); Allstair Stuart Donovan, Reston, VA (US)

Correspondence Address: MINTZ LEVIN COHN FERRIS,, GLOVSKY AND POPEO PC, Suite 400, 11911 Freedom Drive, Reston, VA, 20190, US

(21) Appl. No.: 09/917,810

(22) Filed: Jul. 31, 2001

Related U.S. Application Data
(63) Continuation of application No. 09/698,073, filed on Oct. 30, 2000, now abandoned.
(60) Provisional application No. 60/162,129, filed on Oct. 29, 1999.
(60) Provisional application No. 60/162,125, filed on Oct. 29, 1999.
(60) Provisional application No. 60/194,027, filed on Apr. 3, 2000.

(51) Int. Cl. G06F 17/60

(52) U.S. Cl. 705/1

(57) ABSTRACT

A system and method of providing data exchange between an aggregate transaction engine and multiple sources. The system may include an aggregate transaction engine including a user interface server, a source interface server, and a transaction server. The source interface server may include data scraping protocols, electronic data interface protocols, and database query protocols for communicating with the multiple sources. The aggregate transaction engine may include a search module for accessing data describing at least one offering available from the multiple source systems. The aggregate transaction engine may include an ordering module for placing a plurality of orders to the multiple source systems in response to an ordering transaction from a user. The search module and ordering module may include predefined data transfer protocols customized for communicating with the particular source system. A module library may be provided for assembling custom data transfer protocols for data exchange with the multiple source systems. A method of customization may be followed that includes evaluating a source system, selecting a base data transfer module, and customizing the base data transfer module according to the data exchange standards of the source system.

### FIELD OF THE INVENTION

This application is a conversion of the U.S. provisional applications serial Nos.: 60/162,129, entitled “SYSTEM AND METHOD FOR SINGLE SOURCE INTERACTIONS WITH MULTIPLE MERCHANT WEB SITES” filed on Oct. 29, 1999; 60/162,125, entitled “SYSTEM AND METHOD FOR DEFINING AUTOMATED ACCESS PROTOCOLS FOR ELECTRONIC TRANSACTIONS WITH MULTIPLE MERCHANTS” filed on Oct. 29, 1999; and 60/194,027, entitled “SYSTEM AND METHOD FOR INTEGRATED CONSUMER SERVICES FOR ELECTRONIC COMMERCE WITH MULTIPLE MERCHANTS” filed on Apr. 3, 2000. The invention relates to data exchange for electronic transactions with multiple sources.

### BACKGROUND OF THE INVENTION

The availability of commercial goods for sale on the Internet has skyrocketed over the past few years. “E-commerce” has become a catch phrase commonly heard in all sectors and the growth of Internet retailers shows no sign of slowing. That which started as a proliferation of sellers of books, music, computers, and software has created a vibrant retail marketplace of countless merchants selling all manner of goods. The ranks of Internet retailers now includes sellers of everything from furniture to automobiles to prescription drugs to plane tickets. Everything imaginable is now sold over the Internet and thousands of merchants with their own unique Web sites and business methods are clamoring for attention from users.

As the number of e-commerce enabled Web sites increases, users are spending more time searching for products and services of interest. Users may use all manner of search and comparison sites, consumer reports and reviews, and general Internet searches. The convenience of comparison shopping on the Internet has not been lost on consumers. The Internet provides numerous sites for conducting price comparison searches, as well as sites containing product reviews, both of which fostering side-by-side comparisons of numerous competing products. Search and comparison sites are frequently linked to one or more on-line merchant's Web sites, with the expectation, by both merchants and consumers, that a search and comparison may lead directly to an Internet transaction. This revolution in consumer awareness and competitive marketing has heightened demand for increased efficiency and convenience when moving between search and comparison sites and actual merchant sites.

Unfortunately, if a user intends to purchase products from two or more different Web sites, the user typically must register and execute separate transactions with the different merchant sites. Separate transactions frequently require repeated entry of personal and purchase data or, at the very least, the entry of account information or passwords. Another result of multiple transactions is that items ordered from different Web sites may arrive at different times via different delivery methods. Shipments from a number of different vendors may increase overall shipping costs and render tracking deliveries from different sources more complicated.

Another drawback is that the user may have to create and/or manage a number of different accounts with each of the merchants. Creation and management of these accounts may require repeatedly providing the same input to each of the different accounts. The user also must remember user names and passwords for each of these different accounts.

Great advantage could be gained by allowing a user to enjoy the variety and convenience of Internet shopping without the difficulties posed by purchasing from numerous independent vendors. A single aggregate transaction engine which could provide access to the content of numerous diverse source systems, allow searching and comparison of these source systems through a single interface, and allow registration, purchasing, and order tracking of a single aggregated order from multiple source systems would be a substantial improvement.

One way to realize such an aggregate transaction engine may be through the harmonization of data storage and transfer among the various merchants. This would allow an aggregate transaction engine to use standardized protocols for handling data brokering between merchants and users. Many merchants and other sources of goods and services (e.g., individual sellers, auction and group buy systems, and other service providers) are struggling with middleware platforms for allowing interaction between various Internet businesses. Further, various standards are being promoted for the Internet. Thus far, harmonization has been infrequent and e-commerce interconnectivity has generally been limited to negotiated business partnerships. Development of harmonized platforms may be unrealistic, or at least slow, since existing merchants have already made investments in their own e-commerce engines. Existing merchants have established ways of doing business on the Internet, each of which may have differing needs at to the kinds of information required and returned via their retail Web sites.

An aggregate transaction engine may provide the necessary communication protocols to interact with existing sites from a single interface or account. Some challenges may exist in providing an aggregate transaction engine to interact with a plurality of source systems. All source systems may maintain product information in slightly different formats. Therefore, ensuring accurate searches and comparisons among source systems may be difficult. Further, customized protocols for registering accounts or logging into a given site, for adding items to a “shopping cart” or consummating a transaction, and for checking or altering the status of an order all present difficulties. Particularly difficult for an aggregate transaction engine would be controlling the functions of user-to-merchant interactions which often requires manipulation of the user system.

Merchant Web sites and other source systems frequently use multi-screen interfaces to handle any given function. To accomplish extended interactions, merchant Web sites frequently maintain some sort of state information. State information prevents transaction data from being lost halfway through a transaction if a connection is interrupted. Some state information may be deposited on and read from a user system. For example, many sites deposit cookies (small pieces of code) on user computers to track the transaction data. It could be difficult for an aggregate transaction engine to catch and manage cookies destined for user systems.

Merchant Web sites may also use Java script to create pop-up menus or other means for delivering and receiving data outside of a standard single browser window interface. Java script and other instruction sets may be intended to provide instructions directly to the user's computer. An aggregate transaction engine may have difficulties determining how to deal with instruction sets directed to user systems.

In any transaction, and especially purchase transactions, sources and users my both wish to routinely establish and terminate secure connections. Protection of credit card information is typically the most prevalent reason for establishing such a secure connection. Secure connections use a security protocol to encrypt data before transmission between the source system and the user's computer or other terminal device. In order to provide the necessary data formatting and filtering, a transaction engine would need to be interposed within the data flow and utilize the secure data, without compromising it. This may present further challenges to aggregate transaction engines.

### SUMMARY OF THE INVENTION

These and other drawbacks of providing shopping portal systems for Internet transactions are overcome by the invention of the preferred embodiments.

It is an object of the preferred embodiments to provide a system and method of providing data exchange between an aggregate transaction engine and multiple sources.

The invention may include a networked system enabling aggregate transactions for offerings from multiple sources. The system may include an aggregator system connected to multiple source systems via a communication network (e.g., the Internet, a satellite broadcast system, cellular network, or other communication network). The aggregator system may include a user interface server, a source interface server, an aggregator transaction server, and one or more data sources. The user interface server may include a Web server, wireless application server, interactive television server, or other system. The source interface server may include a business-to-business server with custom data exchange protocols for data scraping, proprietary data transfer, and/or direct database access. The data sources may include a system data source, a source interface data source, and an offering data source. The offering data source may be an aggregate offering database, including data related to offerings from the multiple source systems. The system may include a plurality of end user devices for accessing the aggregator system, such as personal computers, Internet appliances, wireless devices, interactive televisions, and other devices.

These and other objects may also be achieved by a system for providing electronic transactions with a plurality of sources for a user over a network. The system may be an aggregate transaction engine including a search module for accessing data describing at least one offering available from at least one of a plurality of source systems. The system may also include an ordering module for placing a plurality of orders to the plurality of source systems in response to at least one ordering transaction for at least one purchase item selected by one or more users. The search module and the ordering module may utilize predefined data transfer protocols customized for communicating with at least one of the plurality of source systems. The predefined communication protocols may include data scraping agents, negotiated data transfer protocols, and source system database access protocols.

These and other objects may also be achieved by a module library for assembling custom data transfer protocols for data exchange with a plurality of sources. The module library includes a plurality of base data transfer modules for customizing according to the data exchange requirements of a source system. The base data transfer modules may include search modules, comparison modules, ordering modules, and data update modules. Search modules may include modules predefined to acquire data descriptive of a category of offerings. Comparison modules may include modules predefined to classify data descriptive of a category of offerings for comparison. Ordering modules may include register modules, login modules, purchase modules, and status modules. Data update modules may include modules predefined to update an aggregate offering database. Purchase modules and status modules may include modules for batch exchange of order data and status data for a plurality of user orders. The base modules may include at least one of data scraping agents, electronic data interface protocols, and database query protocols.

These and other objects may also be achieved by a method of customizing data transfer protocols according to an analysis of source systems. The method may include the steps of evaluating a source system, selecting a data transfer module from a module library, and customizing the module according to the data exchange standards of the source system. A template of the data interface of the source system may be created and customization of the module may be accomplished according to the template. Data transfer modules may include data scraping protocols, electronic data transfer protocols, and database query protocols. Search modules, comparison modules, ordering modules, and a data update modules may be selected and customized. Modules may be customized for handling specific offering categories from the source system.

Other features and advantages of the present invention will be apparent to one of ordinary skill in the art upon reviewing the detailed description of the present invention.

### BRIEF DESCRIPTION OF THE DRAWINGS

FIG. 1 is a schematic diagram of a system in accordance with an embodiment of the invention.

FIG. 2 is a schematic diagram of a system architecture for a transaction system in accordance with an embodiment of the invention.

FIG. 3 is a schematic diagram of a system for aggregate electronic transactions to multiple source systems according to an embodiment of the invention.

FIG. 4 is a schematic diagram of a customizable module library, a library of source specific protocols, and source templates in accordance with an embodiment of the invention.

FIG. 5 is an embodiment of a method for defining data transfer protocols for data exchange with multiple source systems.

### DETAILED DESCRIPTION OF THE PREFERRED EMBODIMENTS

An aggregate transaction engine may be developed for interacting with the varying data exchange protocols of various sources. The aggregate transaction engine may act as a gate keeper and translator for data exchange between the source systems and the end users. On the user side, the system may accumulate and store standard information, as well as prompt for transaction specific information. The user information must be properly identified by the system so that it can be formatted for presentation to the source system. The source system may provide information on available products and prompt for user input necessary to complete various stages of interaction, with an eye to consummating a sales transaction.

A aggregate transaction engine may create a need for automated interaction with a merchant site. In some systems, the user may not even be aware that the aggregate transaction engine is accessing a source system. One example of the need for automation might be the collection of items from a variety of merchants in a common shopping cart because the consummation of such a transaction may require automated interaction with multiple merchant systems. Similarly, when a source is selected by a user, the user may be required to establish an account with the source system.

In order to provide automated interaction with a source system, the aggregate transaction engine should be able to identify the interactions expected by the source system, as well as how the source system will return data. A profile or template may be generated of the information requested by a given source system. This template may be specific to a given source system and large differences may exist from source to source. In addition to the actual data required, a source system template might include the structure of the prompts, the use of cookies, queries to the user system, instruction sets to be passed to the user system, security protocols, and methods for maintaining state information. This template may be used to generate one or more data transfer protocols that the aggregate transaction engine will use to interact with the source system.

In order to generate the merchant site profile and be able to use it to create a protocol, the merchant site may need to be evaluated to determine how it works. Once it is known in what order a merchant site prompts for what data and how and when it interacts with a user's computer, a protocol can be developed for interacting with that site.

While every source system may be different, there are certain types of information and types of interaction which are common among them. For example, there are certain components of a shipping address which may routinely be prompted for. Similarly, each source system may have a purchasing routine, a registration and log in routine, and an order status verification routine. These units of interaction may be more or less discretely organized depending on the site.

Common information types allow an aggregate transaction engine to interact with different source systems from a common body of user data. Common units of interaction provide a starting point for constructing protocols for interacting with source systems. Common product categories may provide a more specific starting point for constructing protocols, especially those protocols unique to a product category or defined by a product category. A library of modules corresponding to common routines may provide a starting place for assembling a protocol for interacting with a given source system. Modules may be assembled and customized to create a protocol which automates interaction with a source system. These customized protocols may be compiled in a database and used by an aggregate transaction engine to govern interactions with the source systems in response to user input.

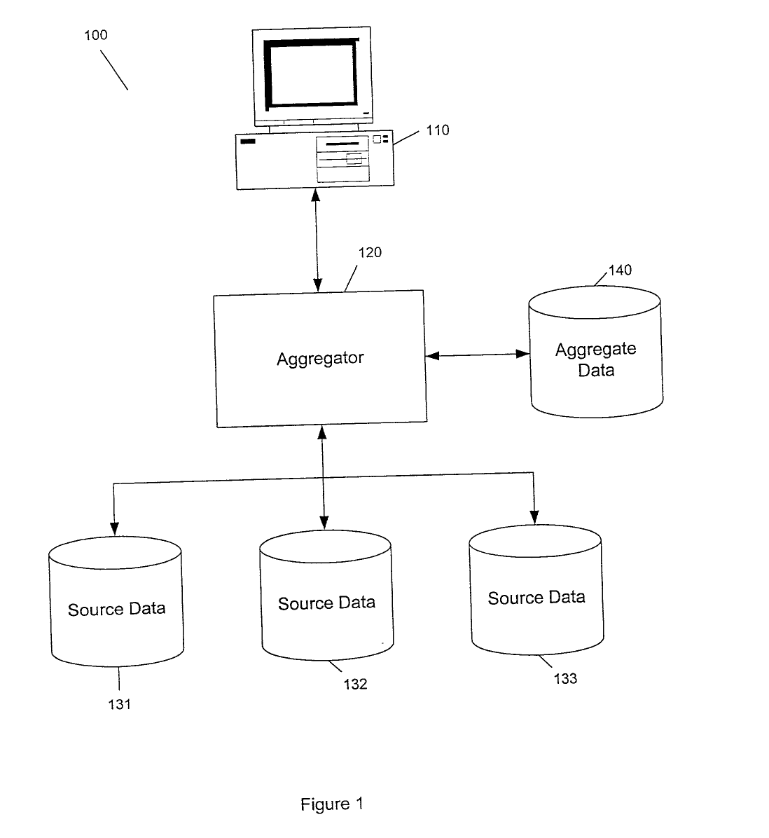

These and other embodiments of the invention are described below with regard to FIGS. 1-5. Several of the figures described below depict multiple functional and data modules according to one or more embodiments of the invention. The modules contain a combination of software and hardware for performing a task or set of tasks. A data processor, memory, and an instruction set (i.e., computer code) may be all that are needed to carry out the tasks for a given embodiment of each module. More commonly, however, multiple input and output devices, short term and long term memory systems, layers of computer code (i.e., operating system, application software, etc.), communication devices, and multiple processors may be used. Further, multiple modules may share the same hardware and portions of a software library. In some cases, a module may contain one or more other modules. As will be understood by those of ordinary skill in the art, the modules described herein may be embodied in a large number of equivalent combinations of code objects and hardware. The units represented by the modules described are conceptual and should not be construed as a limiting structure for the hardware and software combinations capable of executing the modules' tasks.

FIG. 1 is a schematic diagram of a system 100 for providing aggregate services to a user. User terminal device 110, such as a personal computer, is connected to an Aggregator 120, such as a Web site and associated back-end applications. User terminal device 110 may include any input/output device for communicating data over a network, such as a personal computer, telephone, personal digital assistant, wireless device, Internet appliance, interactive television, network game console, or other device. Aggregator 120 may be any system, device, or application which collects comparable data or services from multiple data sources, such as electronic service providers of all kinds, and presents the collected data or services through a combined interface to an end user. Aggregator 120 is connected to a number of data sources, such as data sources 131, 132, 133, and 140. In one embodiment, data sources 131, 132, and 133 are each source systems, such as source Web sites offering transactions for goods and services and associated applications. In one embodiment, data source 140 is a system database associated with Aggregator 120. Data source 140 may include a database of offering data from data sources 131, 132, and 133. Aggregator 120 collects data from, or otherwise uses the resources of, each of data sources 131, 132, and 133 in order to provide a combined interface to the data and/or services provided by data sources 131, 132, and 133. Aggregator 120 increases user efficiency by allowing the user to access the services of multiple service providers (e.g., multiple Web sites) through a single interface (e.g., an aggregator Web site).

For example, Alex wants to purchase a few CDs on the Internet. Alex tries to be an educated consumer and prefers to comparison shop when time allows. He sits down at his computer (terminal device 110) and directs his browser to a shopping aggregator Web site (Aggregator 120). The shopping aggregator Web site provides access to Barnes&Noble.com™, CDUniverse™, and CDNow™ (data sources 131, 132, and 133). Alex enters an album title into an aggregate search engine that retrieves purchase information for the album from all three Web sites and displays the information for side-by-side comparison. Alex selects a CD from one of the merchants and adds it to his aggregate shopping cart (data source 140). After searching for several CDs, Alex's shopping cart now contains a CD or two from each merchant. Alex decides to check out and purchases all of the CDs from the respective merchants through an aggregate checkout transaction. Alex has searched for, compared, selected, and purchased goods from three different merchants without ever leaving the aggregate shopping site.

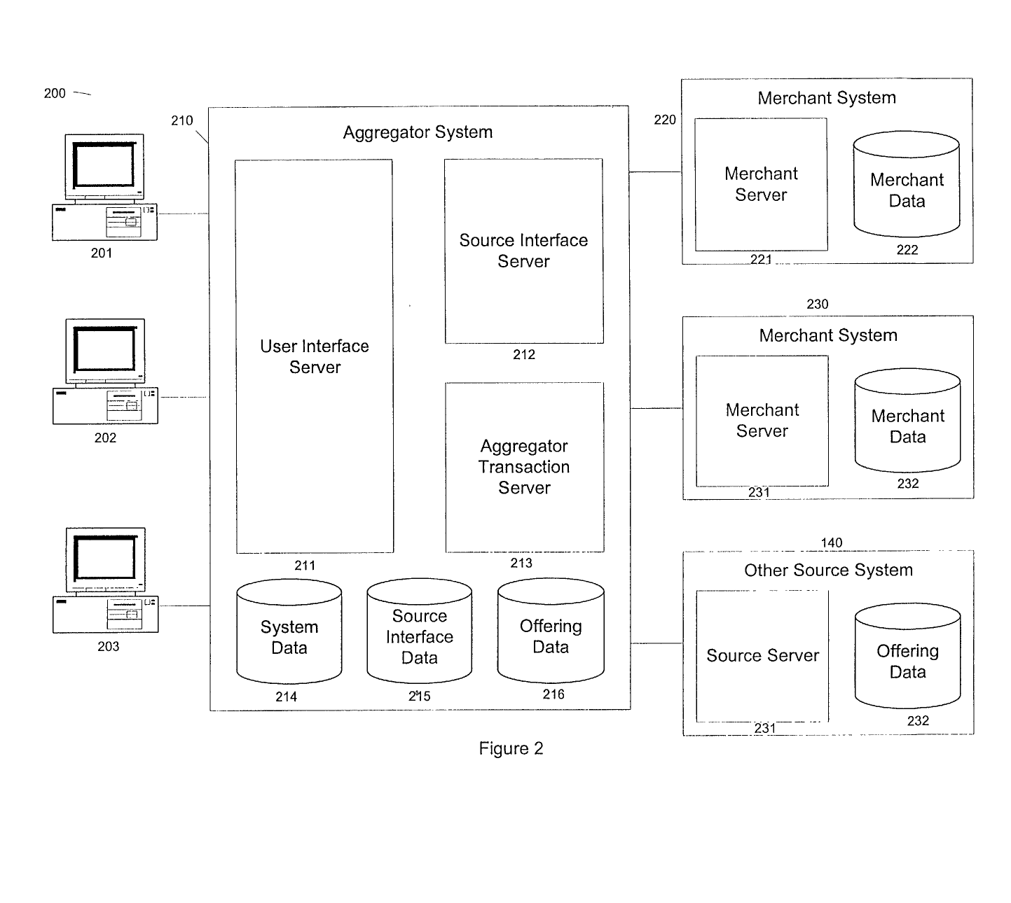

FIG. 2 is a schematic diagram of a network system 200 in accordance with an embodiment of the invention. In a preferred embodiment, a computer system 210 may communicate with multiple user systems incorporating terminal devices, such as a personal computers 201, 202, and 203. Computer system 210 may host an aggregator Web site available to personal computers 201, 202, and 203 over a network, such as the Internet. Computer system 210 may also communicate with multiple source systems, such as Merchant Systems 220 and 230, and Other Source System 240. Consumers using personal computers 201, 202, and 203 may utilize the e-commerce functions and consumer resources of source systems 220, 230, and 240 through the Web site hosted on computer system 210.

Personal computers 201, 202, and 203 may be disposed in homes, businesses, public clusters, retail locations, and other locations. Other terminal devices for system 200 may include interactive televisions, specialized Internet appliances, kiosks or automatic teller machines (ATMs), Internet enabled wireless telephones and personal digital assistants (PDAs), and other networkable devices having computer processors and input/output capabilities. In a preferred embodiment, a consumer may use any Web enabled terminal device and standard or custom Web browsing software to access computer system 210.

Computer system 210 includes a system of servers and data sources for enabling a consumer service system. Computer system 210 may act as a gateway between user systems, such as personal computers 201, 202, and 203, and source systems, such as Merchant Systems 220 and 230 and Other Source System 240. Data flow between Computer system 210 and user systems, source systems, and other systems may be directed through a network, such as the Internet, or another data communication system. Computer system 210 may include multiple servers, such as Interface Server 211, Source Interface server 212, or Transaction Server 213. The functions of these servers may be combined in a single server or distributed over any number of interconnected servers. Computer system 210 may support queries from and data exchange with any number of different user systems and source systems at the same time, so that multiple different consumers may simultaneously access the information and functions of computer system 210. Computer system 210 may also include multiple data sources, such as System Data source 214, Source Interface Data source 215, and Account Data source 216. Any number and form of data sources may be used. In one embodiment, the data sources may be integrated in a single database for organization, modification, and retrieval, such as an Oracle® database. The data sources may be integrated with the server system, provided in interconnected data repositories, or provided through network access to a remote storage facility. The division of servers and data sources depicted in FIG. 2 is illustrative only and should not be viewed as limiting the operable configurations for enabling the embodiments of the invention.

The servers, User Interface Server 211, Source Interface Server 212, and Transaction Server 213, may cooperate as operative hardware and host the software for enabling an integrated service system. The data sources, System Data source 214, Source Interface Data source 215, and Account Data source 216, provide structured data for enabling at least a portion of the content and functions of the integrated consumer service system. User Interface Server 211 provides a user interface for consumers and/or businesses, such as users of personal computers 201, 202, and 203, to access the service system for utilizing the information and services of service providers 220, 230, and 240. User Interface Server 211 may present a Web site for access over the Internet at a particular Universal Resource Locator address, or URL. User Interface Server 211 may host multiple Web pages containing both static and dynamic content, such as a home page and multiple hierarchical Web pages for selectively providing and receiving information. Web page documents and associated program code may be stored in System Data source 214. Background operations related to Web site functions, such as user log in, new account generation, browsing and selecting purchase items, executing a user order transaction, order status inquiries, and other services, may be provided by Transaction Server 212. Functions in Transaction Server 212 may be executed through a plurality program code files in a programming platform such as Java®. Some functions may include data validation, data formatting, query formatting, data handling, data processing, and other functions. User account data, including log in names, passwords, contact information, transaction histories, merchant account information, and other information may be stored in Account Data source 216. Data for submission to and retrieval from the service provider systems may be handled through Source Interface Server 212. Source Interface server 212 may by a business-to-business (B2B) server using customized protocols, such as data queries and submissions, data scraping agents (e.g. Web Interface Developer Language (WIDL) agents), Electronic Data Interface (EDI), database query protocols, or any other form of data submission and retrieval compatible with a particular service provider system, to interact with each source system. The customized protocols may navigate a user interface, such as a source system's Web site, or may use direct data transfer protocols to back-end transaction servers and data repositories. Source system specific protocols and other source information may be stored in Source Interface Data source 215.

Source systems, such as Merchant Systems 220 and 230 and Other Source System 240, may be any network accessible system providing user oriented services. Merchant Systems 220 and 230 may include systems enabled for offering goods or services and accepting binding purchase transactions over a network, such as Egghead.com™, Barnes&Noble.com™, CDUniverse™, and other Internet retailers. Merchant Systems 220 and 230 may also include auctions and exchanges for conducting transactions with individual sellers, group buy services, distributors, manufacturers and other sellers of goods and services. Other Source system 240 may include any system providing user oriented services which provides additional user convenience by being integrated into a single interface for electronic shopping, such as e-centives™, America Online™ wallets, and other service providers. Service provider systems may include servers and data sources, such as Merchant Server 221 and Merchant Data source 222 in Merchant System 220, Merchant Server 231 and Merchant Data source 232 in Merchant System 230, and Service Server 241 and Service Data source 242 in Service Provider System 240. Computer system 210 may communicate with any part of a source system providing functions and information useful to the service system, such as by direct data query to a data source or through a server based transaction.

In one embodiment, computer system 210 utilizes a plurality of protocols customized for interacting with each merchant, service provider, or other source system. A library of such customized protocols may allow Aggregator System 210 to interact with a large number of merchant and other service provider systems for a wide variety of data retrieval and data submission transactions within standardized operating procedures. The use of a library of custom protocols that may be modularly inserted into a larger operational routine may allow computer system 210 to interact with a plurality of systems with highly variable data storage and retrieval and transactional systems. For example, merchant A may have a particular configuration for accepting a user name and password through its Web site for initiating a search request. Merchant B, on the other hand, allows direct access to its product search engine through an EDI interface that is more efficient than accessing Merchant B's search engine through its Web site. Computer system 210 may have a specific “Search Merchant A” protocol and a specific “Search Merchant B” protocol which use different communication protocols and data formats appropriate to the respective merchant systems. Both protocols may be initiated by computer system 210's operational routine for conducting product searches. Modularity provides added expandability which may allow existing transactions to be supplemented with new protocols for additional transaction types (such as the addition of a protocol to access a new wish list function within an existing merchant system) or new protocols for additional service providers (such as the addition of a new merchant system). In one embodiment, search, comparison, price verification, order submission, transaction monitoring, account maintenance, content retrieval, and other transaction types may be represented by a custom protocol for each service provider system. In one embodiment, functional protocol types may be further subdivided into sub-categories for product type, organizer type, payment method type, incentive type, and similar functional/conceptual subdivisions for promoting added modularity and customizability.

A preferred method for defining protocols for interacting with source systems with interfaces accessible over the World Wide Web, is the use of data scraping agents or protocols based on the Web Interface Definition Language (WIDL). Accessing data via the World Wide Web may present difficulties where Web site data sources are retained in traditional HTML format. While data may be accessed more efficiently when stored in Extensible Markup Language (XML), many existing sites have not made the transition to the XML standard. WIDL is an application of XML which allows the resources of the World Wide Web to be described as functional interfaces that can be accessed by remote systems over standard Web protocols. WIDL provides a practical and cost-effective means for diverse systems to be rapidly integrated across the Internet.

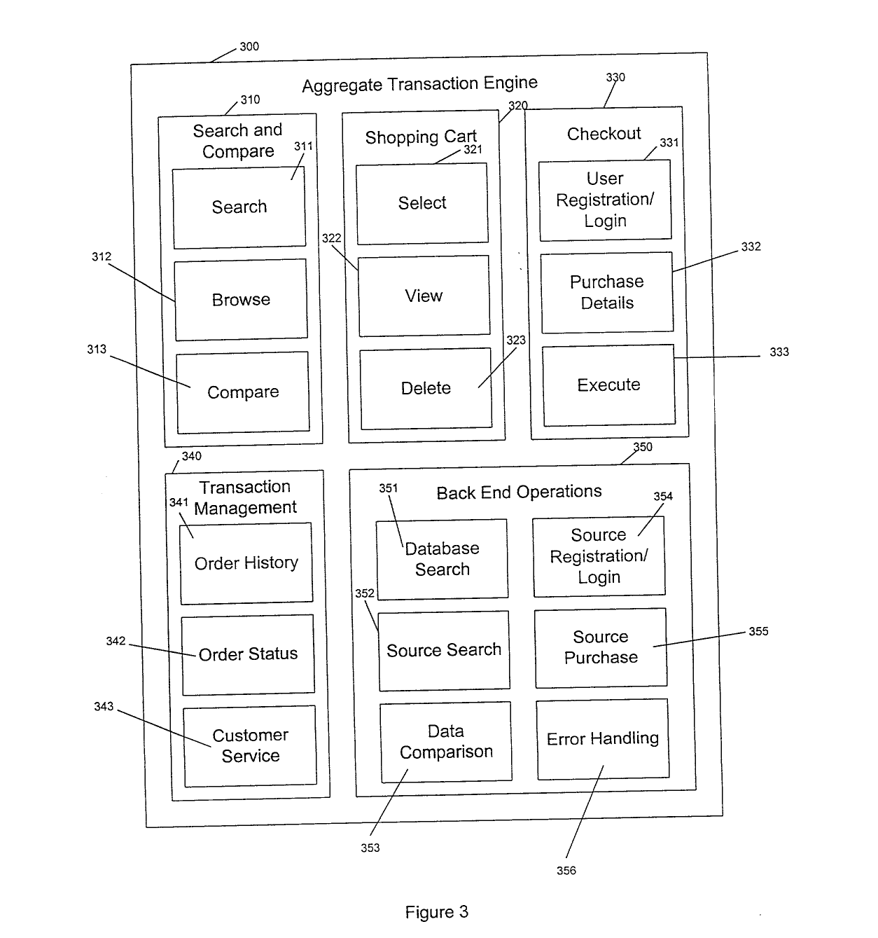

FIG. 3 shows a schematic diagram of the functional modules of an example Aggregate Transaction Engine 300. Such an engine may be use a system substantially as shown and described with regard to FIGS. 1 and 2. Functional modules may include a mixture of modules for providing functionality to a user, such as through User Interface Server 211 in FIG. 2, modules for providing a function based upon interactions with a source system, such as through Source Interface Server 211, and modules for conducting function internal to the system hosting the Aggregate Transaction Engine 300. In some cases, at least a portion of the functions utilize the resources of Aggregator Transaction Server 213.

In one embodiment, Aggregate Transaction Engine 300 may include a number of user functions, such as Search and Compare module 310, Shopping Cart module 320, Checkout module 330, and Transaction Management Module 340. Search and Compare module 330 may include a Search module 311 for searching for a particular offering based upon user search criteria, a Browse module 312 for allowing a user to browse through hierarchical offering listings, and a Compare module 313 for comparing similar products. Many other configurations of a search and compare module are possible and will be readily identifiable by those of skill in the art. Shopping Cart module 320 may include a Select module 321 for selecting an offering identified through Search and Compare module 310, a View module 322 for viewing the contents of a user's shopping cart (e.g., selected offerings), and a Delete module 323 for removing a previously selected offering from the shopping cart. The shopping cart module described includes only a few examples of the many shopping cart related functions that may be provided through an electronic shopping cart. Checkout module 330 may include a User Registration/Login module 321 for identifying the user to the Aggregate Transaction Engine 300, a Purchase Details module 322 for allowing a user to provide purchase details for the user's selected purchase items, and an Execute module 323 which completes a single user purchase transaction for purchases of offerings from multiple source systems. Transaction Management module 340 may include an Order History module 341 for allowing a user to view purchase history including orders placed through multiple source systems, an Order Status module 342 for allowing a user to view the current status of a previously placed order, and a Customer Service module 343 for providing access to customer service for the source systems.

Aggregate Transaction Engine 300 may include back end functions for interacting with source systems and or internal data sources. Back end functional modules may include a Database Search module 351, a Source Search module 352, a Data Comparison module 353, a Source Registration/Login module 354, a Source Purchase module 355, and an Error Handling module 356.

Database Search module 351 may search for static offering data within an aggregate offering database. In one embodiment, Database Search module 351 may include protocols for updating the aggregate offering database based upon search results returned from source system and/or data updates via download, data feed, systematic query, or another method.

Source Search module 352 may represent a basic protocol for conducting a search on one or more source systems. In one embodiment, the search module simulates a local offering database search. Item details (description, pictures, price, etc) may be obtained from source systems and presented to the user based on the search criteria such as name, price, age group, keyword, etc. Search routines may be defined according to offering categories (such as Books, Music, Movies, etc) for limiting extraneous searches at source systems that do not carry the product in question. In one embodiment, Source Search module 352 may comprise a WIDL service for accessing search engines already available on existing source systems.

Data Comparison module 353 may represent a basic protocol for conducting a comparison of search results retrieved from one or more source systems. In one embodiment, items are compared based on price, shipping/handling costs and availability. In one embodiment, a comparison engine contacts each source system asynchronously and retrieves the comparison information. In one embodiment, categories which are hard to compare due to the lack of uniform product identification codes (such as Toys, Flowers, Apparel, etc.) may not have a comparison module. These categories may still be serviced by the search module. A further difficulty may need to be overcome where source systems use a variation on UPCs, ISBNs, or other product codes within their own systems. In order to guarantee accuracy of comparisons across source systems, search and comparison modules may need to be customized to interpret a particular merchant's use of codes. For example, some merchants may only use the portion of a product's UPC sufficient to distinguish the product within their own systems. Further, some merchants may add digits to the beginning or end of a product code as part of their in-house stock tracking system. In one embodiment, Data Comparison module 353 may be able to extract standard product codes or portions thereof for making accurate comparisons across source systems. Compare module 353 may be customized to individual source systems' uses of product codes.

Still other source systems may not use product codes of any kind or may use product codes unrelated to any standard product tracking system. In one embodiment, comparison modules may be able to retrieve and compare other product information in order to ensure accurate product comparisons. For example, a comparison module for music might initially use title and artist to locate similar products, but might go on to compare label, year, song lists, or other available data to ensure an accurate comparison. In one embodiment, Data Comparison module 353 may comprise a WIDL service for accessing search engines or other product information resources already available on existing source systems.

Source Registration/Login module 354 may be included to allow Aggregate Transaction Engine 300 to consummate a purchase in the user's name at a source system. In one embodiment, first time users of the source system may be required to register at with the source system. This module allows the engine to automatically complete the registration based on user information available to the engine. In one embodiment, non-first time purchasers may be required to log in at a source system to complete a purchase and this module may also automate that function. Registration may be particularly important where users can accumulate rewards for frequent purchases or wish to have purchases contribute to a customer profile used to deliver personalized content. In one embodiment, Source Registration/Login module 354 may comprise a WIDL service for accessing the registration and log in transactions of the source systems.

Source Purchase module 354 may allow Aggregate Transaction Engine 300 to consummate purchase transactions with the source systems based on the offerings selected and shipping and billing information input by the user responsive to Check Out module 330. In one embodiment, Source Purchase module 354 uses user information to automatically complete the required purchase transaction requirements on the source systems. In one embodiment, Source Purchase module 354 may comprise a WIDL service for accessing the purchase transaction routine of the source systems. For example, the Source Purchase module 354 may navigate the shopping cart and checkout functions of the source system and provide appropriate input to execute a purchase transaction. In one embodiment, Source Purchase module 354 may include a module for aggregating purchase from multiple users and placing a batch order to a source system through a method other than the source systems user interface (e.g., via an EDI protocol or direct database access).

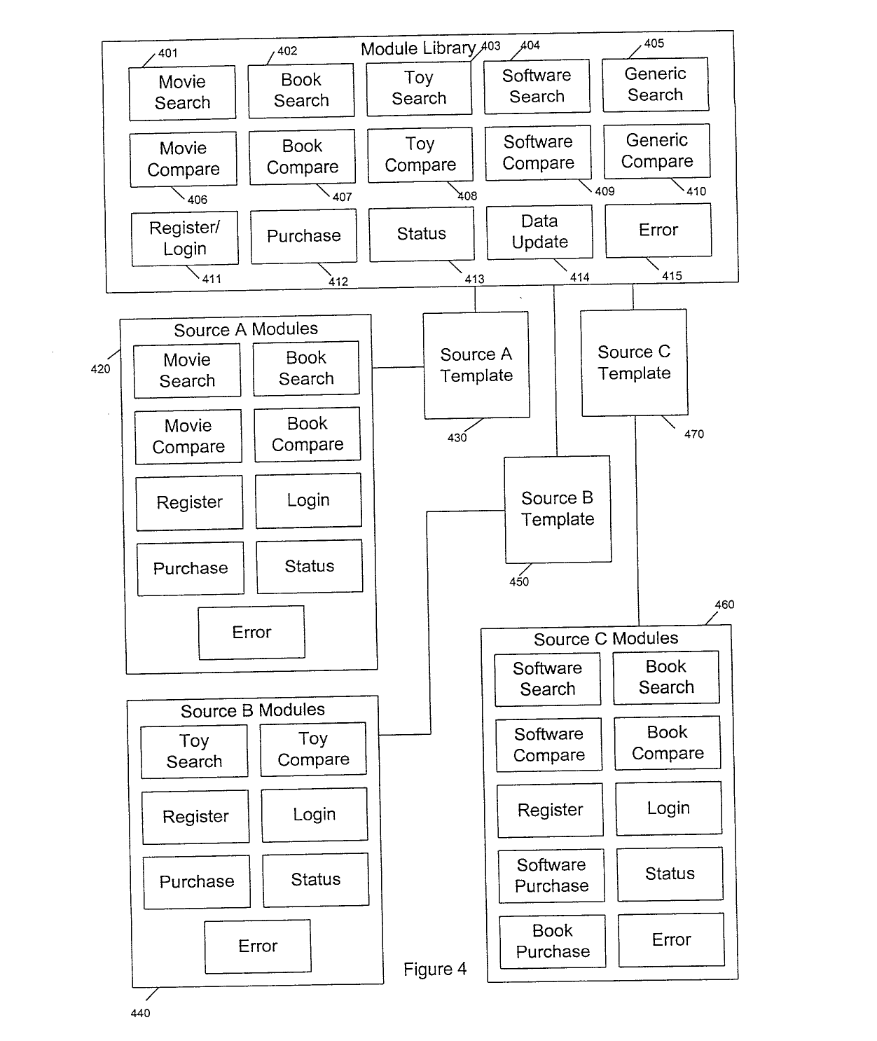

A purchasing status module (such as that shown as Status module 412 in FIG. 4) may allow Aggregate Transaction Engine 300 to query source systems in order to update order information and maintain a current order history for use in Order History module 341. In one embodiment, the purchasing status module may be responsive to e-mail notifications provided by the source system. In one embodiment, the status module may access the order status information on the source system. In one embodiment, a status module may comprise a WIDL service for accessing the order status inquiry system of the source systems.

Error Handling module 356 may allow Aggregate Transaction Engine 300 to verify the location and availability of source system resources. Resource verification may allow Aggregate Transaction Engine 300 to prevent error causing transactions from being attempted at a given source system by removing the resource if it becomes unavailable or unstable for any reason. In one embodiment, Error Handling module 356 may periodically attempt transactions of varying kinds with a source system in the engine's protocols. Error Handling module 356 may automatically return error information in the event that resource availability changes, for example, due to a change in URL or a reconfiguration or update of a system which changes resource formatting. Error Handling module 356 may allow the engine to provide an alert of the change or temporarily remove the afflicted source system from engine protocols. In one embodiment, Error Handling module 356 may comprise a WIDL service which may attempt one or more transactions at a source system and handle returned error messages.

According to one embodiment of the invention, a library of customizable base modules may be provided for structuring interactions between the aggregate transaction engine, and a source system. Base Module Library 400 includes multiple base modules to use for customization to generate source specific modules. Base Module Library 400 may include a number of category specific search modules 401, 402, 403, and 404, as well as a generic search module 405. Base Module Library 400 may include a number of category specific compare modules 406, 407, 408, and 409, as well as a generic compare module 410. Base Module Library 400 may include generic ordering modules for customization to each of the source systems or default use, such as Register/Login module 411 and Purchase module 412. Module Library 400 may include other modules for customization to each of the source systems or default use, such as Data Update module 414, and Error module 415. Data Update module 414 allows an aggregate data source to be updated via download, data feed, or another method to supplement data retrieved via source searches.

In one embodiment, a library of source specific customized modules may be generated. Such a library is also depicted in FIG. 4. A library may comprise any number of modules. Modules may be organized by source, transaction, category, or any other common feature. Modules may be cross organized to allow a plurality of means for viewing and selecting modules for use in system protocols. In one embodiment, the customized library contains source data entries 420, 440, and 460. Source data entries may be compilations of source system specific data to be used by an aggregate transaction engine to define interactions between the engine and a source system. Each source data entry may comprise one or more customized modules for use by the system. In one embodiment, these modules may comprise WIDL services. In one embodiment, modules may represent transaction types to be conducted between a system and a source system. In one embodiment, modules may represent transactions related to a offering category. In one embodiment, some or all modules may represent combination transaction/category/source specific modules. In one embodiment, each source data entry may comprise one or more search modules, one or more compare modules, one or more register modules, one or more purchase modules, one or more status modules, or one or more error modules. These modules may be standard modules from a standard module library, such as library 400, may be custom modules based on customization of a standard module, or may be an entirely new module. Each source data entry may not contain every module type. Some merchant sites may not require customized modules. Some module types may not be appropriate for a particular source's offerings (e.g., products or services). In one embodiment, the system may automatically supplement the source data entry modules with standard modules where custom modules are unavailable.

FIG. 4 also shows source templates 430, 450, and 470 to be used in customization of base modules from module library 400. Source Templates 430, 450, and 470 may be descriptive of the data interface of the corresponding source system and may facilitate selection and customization of the base modules.

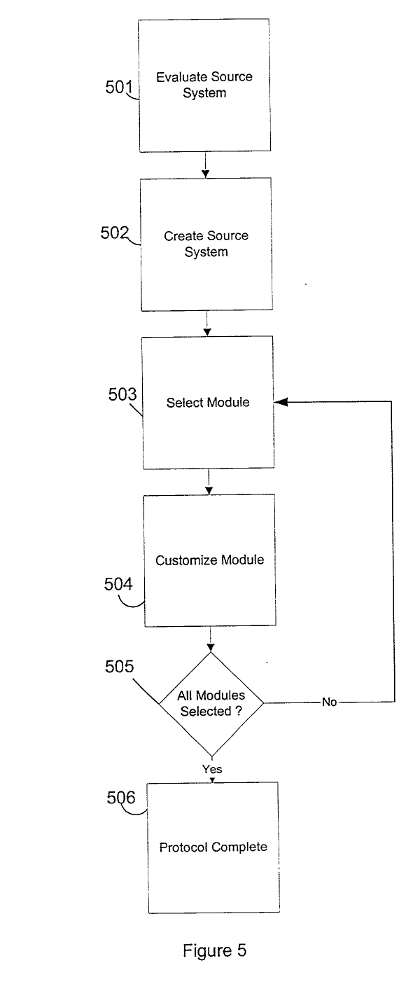

In one embodiment, a method is provided for creating source system specific protocols based on modules customized to the specific requirements of the source system. Such a method is depicted in FIG. 5. Source system specific protocols may be advantageous where more efficient means of communicating with merchant databases or applications are not available. Interaction with merchant sites in traditional HTTP/HTML may be necessary where a more efficient system, such as XML formatting or a business-to-business middleware platform are unavailable or cost prohibitive. In one embodiment, adoption of a standard format or middleware platform may be part of the module selection process for some source systems. Because an aggregate transaction engine may deal with a large number of source systems, it may be advantageous to handle a combination of data transfer protocols, including data scraping agents (e.g., customized WIDL protocols), electronic data interface protocols, database query protocols, and any number of other data transfer protocols.

Step 401 may comprise evaluating a source system. Evaluation may comprise reverse engineering the data flow to and from a given source system. In one embodiment, evaluation may comprise accessing a given source system as a consumer user would and noting the steps necessary to complete various transactions on the site. Evaluation may comprise noting each input provided to the site host in the process of completing a transaction. Evaluation may comprise noting each output from the site host, with particular attention to information queries, instruction sets, cookies, and other special interactions oriented toward manipulating a user system. Evaluation may comprise accessing the source code, such as HTML or other source code, for the site being evaluated. In one embodiment, evaluation may comprise directly analyzing the data flow to and from the source system during a transaction.

Step 402 may comprise creating a source system template. A web site profile may comprise a description of the interactions necessary to complete one or more transactions with a merchant site. In one embodiment, the template is based on the evaluation of a Web site. A template may be manually compiled or automatically compiled during evaluation of a source system. Particular attention may be paid to the prompts, data input locations and styles, screen navigation, and other inputs and outputs exchanged between a user and source system. In one embodiment, certain interactions may be grouped into transaction blocks corresponding to standard modules. In one embodiment, inputs are classified by standard descriptions, such as item identification number, user name, user password, billing name, shipping address, etc. Identification of input according to a description of the data contained within may allow a tag compatible with a markup language (such as XML) to be assigned to the input. A similar process of classification may be conducted for outputs. Where an evaluated source system is similar to standard modules or a previously customized module, a profile may not need to be created and one or more modules may be selected and customized directly.

In step 403, a module may be selected from a library of standard modules. A selected module may correspond to one or more components of interaction with a source system. For example, a Register module might be selected because it corresponds to a series of interactions comprising a registration transaction with the source system. In one embodiment, a template may provide a structure for selecting modules corresponding to grouped transaction blocks. In one embodiment, standard modules may be sorted by both transaction (search, compare, register, purchase, status, error, etc.) and product category (books, music, movies, toys, flowers, etc.). A standard module library may contain separate modules for different transaction/product category combinations, such as book searches, music searches, book purchases, flower status, etc., in any or all combinations.

In step 404, a module may be customized according to the specific pattern of inputs and outputs required to interact with a given source system. Inputs required and outputs generated may vary from source system to source system, even within product categories. Some customization may be necessary to allow the system to extract and return correct data or respond to prompts for input. These inputs and outputs may be generally similar within a product category, but may also contain differences. Differences unique to source systems may provide a basis for customizing the modules for that specific system. Differences may include, but are not limited to, data location, data format, available data, input location, input format, and input requirements. In one embodiment, customization may include modifying modules to handle data intended for storage on consumer user computers, handle instruction sets intended to be executed on consumer user computers, handle data security protocols, and interact with state maintenance protocols on source system interfaces.

In step 405, a decision is made whether all necessary modules have been selected or whether further modules are necessary to completely describe interaction with the source system. If all necessary modules have not been selected, then another module may be selected according to step 403. If all necessary modules have been selected, then the protocol may be completed in step 406.

In step 406, protocols for interacting with a source system for all transactions required by the aggregate transaction engine may be completed. In one embodiment, completed protocols may be stored in a library. Individual modules of completed protocols may be accessed by the system as the need arises to complete user requests and transactions with a given source. In one embodiment, modules may be integrated into the operation of an aggregate transaction engine. Modules in the system may be grouped in protocols for facilitating user access to multiple source systems through a single interaction with the aggregate transaction engine. These protocols may be defined according to accessing a category, a source, a group of categories, a group of sources, or all available resources.

This invention has been described in connection with the preferred embodiments. These embodiments are intended to be illustrative only. It will be readily appreciated by those skilled in the art that modifications may be made to these preferred embodiments without departing from the scope of the invention.

1. A system for providing aggregate transactions for offerings from a plurality of sources over a network, comprising:
a user interface server;
a source interface server, the interface server including custom data transfer protocols for data exchange with the plurality of sources; and
a transaction server in communication with the user interface server and the source interface server, the transaction server receiving user requests for offerings from the plurality of sources through the user interface server and directing a plurality of purchase orders to the plurality of sources for fulfilling the user requests through the source interface server.

2. The system of claim 1, wherein the user interface server is one of a Web server, a wireless application server, a telephone server, and an interactive television server.

3. The system of claim 1, wherein the source interface server includes at least one of a data scraping protocol, a negotiated data transfer protocol, and a database access protocol for data exchange with the plurality of sources.

4. The system of claim 1, further comprising a system data source for storing transaction data related to the user service requests and the purchase orders to the plurality of sources made to fulfill the user service requests.

5. The system of claim 1, further comprising a source interface data source for storing data exchange protocols for the plurality of sources.

6. The system of claim 1, further comprising an offering data source for offerings from the plurality of sources.

7. A system for providing electronic transactions with a plurality of sources for a user over a network comprising:
a search module for accessing data describing at least one offering available from at least one of a plurality of source systems;
an ordering module for placing a plurality of orders to the plurality of source systems in response to at least one ordering transaction for at least one purchase item selected by one or more users.

8. The system of claim 7, wherein the search module includes at least one custom data transfer protocol for communicating with at least one of the plurality of source systems.

9. The system of claim 8, wherein the at least one custom data transfer protocol includes at least one of a data scraping agent, an electronic data interface protocol, and a database access protocol.

10. The system of claim 7, wherein the ordering module includes at least one custom data transfer protocol for communicating with at least one of the plurality of source systems.

11. The system of claim 10, wherein the at least one custom data transfer protocol includes at least one of a data scraping agent, an electronic data interface protocol, and a database access protocol.

12. The system of claim 7, further comprising a comparison module for comparing products or services available from the plurality of source systems.

13. The system of claim 12, wherein the comparison module includes at least one custom data transfer protocol for communicating with at least one of the plurality of source systems.

14. The system of claim 13, wherein the at least one custom data transfer protocol includes at least one of a data scraping agent, an electronic data interface protocol, and a database access protocol.

15. The system of claim 7, further comprising a transaction management module communicating with the plurality of merchant systems for monitoring the status of a plurality of orders placed to the plurality of source systems.

16. The system of claim 15, wherein the transaction management module includes at least one custom data transfer protocol for communicating with at least one of the plurality of source systems.

17. The system of claim 16, wherein the at least one custom data transfer protocol includes at least one of a data scraping agent, an electronic data interface protocol, and a database access protocol.

18. A module library for assembling custom data transfer protocols for data exchange with a plurality of sources, comprising a plurality of base data transfer modules for customization according to the data exchange requirements of a source system.

19. The module library of claim 18, wherein the base data transfer modules include at least one search module.

20. The module library of claim 19, wherein the at least one search module is predefined to acquire data descriptive of a category of offerings.

21. The module library of claim 18, wherein the base data transfer modules include at least one comparison module.

22. The module library if claim 21, wherein the at least one search module is predefined to classify data descriptive of a category of offerings for comparison.

23. The module library of claim 18, wherein the base data transfer modules include at least one ordering module.

24. The module library of claim 23, wherein the at least one ordering module includes a register module.

25. The module library of claim 23, wherein the at least one ordering module includes a login module.

26. The module library of claim 23, wherein the at least one ordering module includes a purchase module.

27. The module library of claim 26, wherein the purchase module includes protocols for batch exchange of order data for a plurality of user purchase orders.

28. The module of claim 23, wherein the at least one ordering module includes a status module.

29. The module of claim 28, wherein the status module includes protocols for batch exchange of status data for a plurality of user purchase orders.

30. The module of claim 18, wherein the base data transfer modules include at least on data update module for updating an aggregate offering database.

31. The module of claim 18, wherein the base data transfer modules include at least one of a data scraping protocol, an electronic data interface protocol, and a database query protocol.

32. A method of customizing data transfer protocols according to an analysis of source systems, comprising the steps of:
evaluating the data interface of a source system;
selecting a base data transfer module from a module library; and,
customizing the base data transfer module according to data exchange standards in the data interface of the source system.

33. The method of claim 32, further comprising the step of creating a template of the data interface of the source system and wherein the step of customizing the base data transfer module includes matching protocols to the template.

34. The method of claim 32, wherein the base data transfer module includes at least one of a data scraping protocol, an electronic data interface protocol, and a database query protocol.

35. The method of claim 32, wherein the base data transfer module includes at least one of a search module, a comparison module, an ordering module, and a data update module.

36. The method of claim 32, wherein the base data transfer module is predefined for data exchange for offering data related to a specific offering category.
